(19) United States
(12) Patent Application Publication
(10) Pub. No.: US 2014/0032190 A1
(43) Pub. Date: Jan. 30, 2014

(54) System and method for identification of conductor surface roughness model for transmission lines

(71) Applicant: Simberian Inc., Las Vegas, NV (US)

(72) Inventor: Yuriy Shlepnev, Las Vegas, NV (US)

(21) Appl. No.: 14/045,392

(22) Filed: Oct. 3, 2013

Related U.S. Application Data
(63) Continuation-in-part of application No. 13/009,541, filed on Jan. 19, 2011, now Pat. No. 8,577,632.
(60) Provisional application No. 61/296,237, filed on Jan. 19, 2010.

(51) Int. Cl. G06F 17/50

(52) U.S. Cl. CPC G06F 17/5018
USPC 703/2

(57) ABSTRACT

A system and method for identification of conductor surface roughness model associated with a transmission line conductor is proposed. A network analyzer measures scattering parameters over a specified frequency band for at least two line segments of different length and substantially identical cross-section with investigated rough conductors. A first engine determines non-reflective (generalized) modal scattering parameters of the difference segment based on the measured scattering parameters of two line segments. A second engine computes generalized modal scattering parameters of the line difference segment by solving Maxwell's equations for geometry of the line cross-section with a given conductor surface roughness model. A third engine performs optimization by changing conductor surface roughness model parameters and model type until the computed and measured generalized modal scattering parameters match. The model that produces generalized modal S-parameters closest to the measured is the final conductor surface roughness model.

### CROSS-REFERENCE TO RELATED APPLICATIONS

The current application is a continuation-in-part of application Ser. No. 13/009,541 filed on Jan. 19, 2011 which claims a priority to 61/296,237 filed on Jan. 19, 2010.

### FIELD OF INVENTION

This invention relates generally to system and method for identification of conductor surface roughness model associated with a transmission line conductor. The system will make use of a network analyzer or equivalent instruments, two transmission line segments, and three engines used for calculations.

### BACKGROUND OF THE INVENTION

During the manufacturing process of printed circuit boards (PCBs) and some types of packages, copper foils are treated to increase surface roughness and improve adhesion to dielectrics in order to avoid delamination. Conductor surface roughness causes signal degradation. Appropriate electrical modeling of conductor roughness on such boards is important for accurate prediction of signal degradation effects as discussed in [1]-[9]. It has been shown in [8] and [9] that conductor roughness increases dissipation factor at higher frequencies and may also change phase and group velocity at all frequencies. PCB copper foil manufacturers do not provide data for the electrical characterization of the copper roughness. Thus, a systematic low-cost characterization of conductor roughness is a must for accurate signal integrity analysis in interconnects with data rates from 6 to 100 Gbps and above (bandwidth from DC to 50 GHz and beyond). The system and method for conductor roughness model identification is the subject of this invention.

There are multiple methods suggested for modelling the conductor roughness effect. One of the first numerical investigations of the roughness effect was done by Morgan in [10] for simplified surfaces with triangular and rectangular grooves. The results of [10] were fitted by authors of [11] and later published in [12]. This model is widely known as Hammerstad's Correction Coefficient (HCC) and was successfully used for analysis of microwave circuits and recently for PCB interconnects as shown in [1] and [2]. Authors of [1]-[6] demonstrated that the model can provide an acceptable degree of accuracy for some types of copper surfaces, but is limited by maximal possible value of dissipation factor increase equal to 2. This limitation can be removed by introducing the roughness factor coefficient as it is suggested in [8], [9]. Hammerstad's model with the roughness factor was called Modified Hammerstad's Correction Coefficient (MHCC).

There have been multiple attempts to derive alternative roughness models based on the rough surface power absorption correction coefficients. A Hemispherical approximation of rough surfaces was used in [3] to derive the correction coefficient. The “Snowball” model was introduced by Paul Huray in [4] to derive a correction coefficient. There were other models resulted in multiple roughness correction coefficients—a review is available in [8], [9]. In practice, all roughness correction coefficients were validated with experiments, but still exhibit one common problem—it is difficult to define the model parameters for any particular case. Measurement results obtained using expensive equipment are typically required to define parameters for a particular model. However, only the RMS peak-to-valley value (Rq) is required for the HCC model. That value is typically available from the copper or laminate manufacturer, but the model is limited to certain types of copper as discussed earlier. The authors of [3] and [4] also pointed out that measurements with a profilometer or from micro-photographs of cross-sections may be misleading in predicting the effect of the roughness topography. It has been shown that the profilometer data or micro-photography may not provide sufficient resolution to capture all the peculiarities of the rough surface to build any model [9].

The subject of this invention is a practical procedure for identifying parameters for any roughness correction coefficient derived in the literature without the complexities required in investigating the micro-structure of the conductor surface. The idea is to avoid the microscopic investigation of the conductor surface and use a roughness correction coefficient as a macro-model with parameters defined by matching simulated and modelled reflection-less generalized modal S-parameters (GMS-parameters). The procedure was first proposed for identification of dielectric models in [13] and [14], and is generalized for any PCB/packaging material identification here. The method was successfully used for identification of roughness parameters in [8], [9] and parameters of nickel plating in [15].

### SUMMARY OF INVENTION

The invention uses a 3D full-wave electromagnetic analysis to compute generalized modal S-parameters of a line segment with all types of conductor and dielectric losses and dispersion included. Any type of transmission line such as stripline, micro-strip, cable, coplanar waveguide can be used. The conductor surface roughness model is derived by comparison of the measured and computed generalized modal S-parameters. The proposed procedure is much less sensitive to the measurement noise and to geometrical differences between the samples then procedures based on extraction of propagation constant (Gamma).

The invention involves with computer-readable medium encoded with a program which, when loaded into a computer, makes the computer perform the steps for identification of conductor surface roughness model associated with a transmission line conductor, the execution of program may be on a computer but also on any digital programmable hardware device or embedded processor within test instruments as a computer-implemented method for, comprising the steps of:

measuring scattering parameters (S-parameters) for at least two transmission line segments of different length and substantially identical cross-section with the investigated rough conductors;

determining non-reflective, generalized modal scattering parameters of the said transmission line segment difference based on the measured S-parameters of two transmission line segments; and

computing generalized modal scattering parameters of the line difference segment by solving Maxwell's equations for geometry of the line cross-section with a given conductor surface roughness model;

wherein the said generalized s-parameter model uses a given conductor surface roughness model and guess values of the model parameters;

wherein the said measuring scattering parameters may be measured using network analyzer including Vector Network Analyzer (VNA) or Time-Domain Network Analyzer (TDNA) or any other instrument or model that measures complex scattering parameters (S-parameters) of a multiport structure; wherein only the standard Short-Open-Load-Through (SOLT) calibration of VNA to the probe tips or to the coaxial connector is optional for the said measurement of S-parameters for the said two line segments;

wherein the said transmission line segments include at least two transmission line segments with substantially identical cross-section with investigated rough conductors and the said two transmission line segments must have different length; wherein one said transmission line segment is shorter and another said transmission line segment is longer;

wherein the geometry of the cross-section and dielectric model parameters must be known and both segments are equipped with either coaxial connectors or conductive probe pads to measure S-parameters over a given frequency range; and wherein the said transmission line segments may be one or multi-conductor strip or micro-strip line, coplanar waveguide or any other line type.

And further comprises the step of

computing generalized modal S-parameters of line segment difference by solving Maxwell's equations for the transmission line cross-section with possibility to choose conductor surface roughness model for at least one dielectric in the line cross-section; and further constructing generalized modal S-parameters of line segment with length l, for a transmission line with N modes (N-conductor line), computed as equation:

$$\tilde{S} g ( f , l ) = [ \begin{matrix}0 & Sm \\ Sm & 0\end{matrix} ] , \\ Sm = diag ( {e}^{- {Γ}_{n} ( f ) \cdot l} , n = 1 , … , N )$$

where Γₙ(f)=αₙ(f)+i·βₙ(f), n=1, . . . , N are complex frequency-dependent propagation constants (Gammas) of the transmission line modes computed by solving Maxwell's equations;

wherein the said solution of the Maxwell's equations can be computed with any numerical method applied to the said line cross-section or to a line segment and such model include dispersive effects of conductors including skin-effect and effect of conductor roughness, high-frequency dispersion due to inhomogeneous dielectric and dispersive dielectric model equivalent to wideband Debye model or multi-pole Debye model.

And further comprising the steps of

a) optimizing said conductor surface roughness model parameters and model type by adjusting conductor surface roughness model parameters and re-simulating the line segment to match magnitude and phase of the measured and simulated generalized modal transmission coefficients; and

b) comparing the measured and computed generalized modal S-parameters, if they match according to a pre-defined criterion, the conductor surface roughness model is found, else if not matched, changing model parameters (or model type) and repeat steps a) and b).

### BRIEF DESCRIPTION OF THE DRAWINGS

FIG. 1 is a flow chart of the dielectric material or conductor surface roughness model identification procedure.

FIG. 2 is a diagram of the Treffitz finite element model of the conductor interior (elements have different size along the Z-axis).

FIG. 3 is a comparison of roughness correction coefficients. Modified Hammerstad's correction coefficient (MHCC)—dash line, Δ=1 um, RF=2.0. Huray's snowball correction coefficient (HSCC)—solid line, sphere radius 0.85 um, tile size 11 um, Ns=20. Simbeor correction coefficient (SCC)—dash-dot line, Δ=1 um, RF=2.0.

FIG. 4 is two graphs showing measured (lines with x, o and *) and computed (lines with squares and +) generalized modal insertion loss (top plot) and group delay (bottom plot) for 2 and 4 inch strip line segments (dielectric model from manufacturer and smooth conductor model).

FIG. 5 is two graphs showing measured (solid lines with x, o and *) and computed (dashed lines with squares and +) generalized modal insertion loss (top plot) and group delay (bottom plot) for 2 and 4 inch strip line segments (dielectric model from manufacturer and MHCC conductor roughness model with SR=0.27, SR=4).

### DETAIL DESCRIPTIONS OF THE INVENTION

### Invention Components

1) Network analyzer such as Vector Network Analyzer (VNA) or Time-Domain Network Analyzer—an apparatus that measures complex scattering parameters (S-parameters) of a multiport structure.
2) At least two transmission line segments with substantially identical cross-section and conductor roughness profile. One or multi-conductor strip or microstrip line, coplanar waveguide or any other line type can be used. Two segments must have different lengths—one segment is shorter and another is longer. Geometry of the cross-section and models for all line dielectrics must be known (separately identified or from specifications). Both segments are equipped with either coaxial connectors or conductive probe pads to measure S-parameters over a given frequency range.
3) Calculator (first engine) of non-reflective or generalized modal S-parameters of line segment difference from two sets of S-parameters measured for two line segments.
4) Calculator (second engine) of non-reflective or generalized modal S-parameters of line segment difference by solving Maxwell's equations for the transmission line cross-section with possibility to choose conductor surface roughness model for at least one surface of the line cross-section.
5) Conductor roughness model parameters optimization procedure (third engine). Model parameters or model type are changing until the computed and measured generalized modal S-parameters match (root-mean square error is below some specified threshold). This procedure may be interactive or completely automated optimization. The model that produces generalized modal S-parameters closest to the measured is the final conductor roughness model.

### Invention Steps

1) Measure scattering parameters (S-parameters) for at least two transmission line segments of different length and substantially identical cross-section and conductor roughness profile filled with dielectric with known dielectric model.
2) Compute generalized modal S-parameters of the transmission line segment difference from the measured S-parameters.
3) Compute generalized modal S-parameter of line segment difference by solving Maxwell's equations for line cross-section with a given conductor surface roughness model.
4) Compare the measured and computed generalized modal S-parameters. If they match according to some criterion, the conductor roughness model is found (end). If not matched, change model parameters (or model type) and repeat steps 3-4.

### Identification of Conductor Roughness Model

Before identification of the conductor roughness model, it is important to verify all dimensions of the test structures on the board. In particular, cross-sections of the transmission lines and length difference between two line pairs have to be accurately measured before the identification. Quality of measured S-parameters has to be estimated and TDR may be used to verify consistency of the test fixtures.

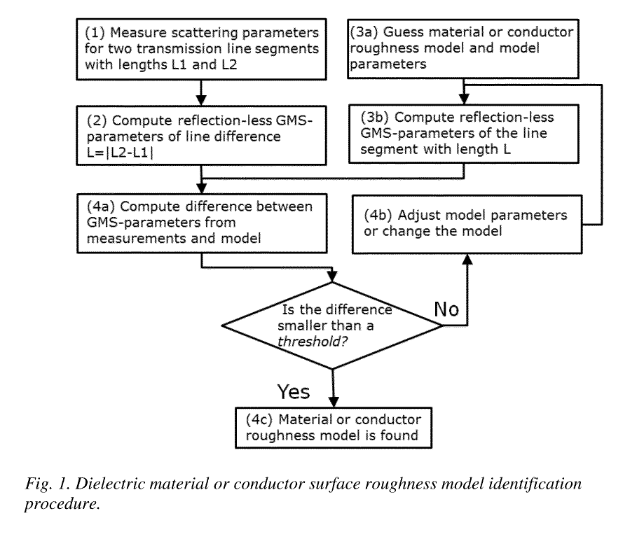

The basic procedure for conductors surface roughness model identification is illustrated in FIG. 1 can be performed as follows:
1) Measure scattering parameters (S-parameters) for at least two transmission line segments of different length (L1 and L2) and substantially identical cross-section and conductor roughness profile filled with dielectric with known dielectric model.
2) Compute generalized modal S-parameters of the transmission line segment difference L=|L2−L1| from the measured S-parameters following procedure described in [13] and [14].
3) Compute GMS-parameters of line segment difference L:
   a. Guess conductor surface roughness model and model parameters.
   b. Compute generalized modal S-parameter of line segment difference L by solving Maxwell's equations for line cross-section with a as described in [13] and [14].
4) Compare GMS-parameters and adjust model to minimize the difference or output the identified model.
   a. Compare the measured and computed generalized modal S-parameters—compute metric of difference of two complex GMS-parameters.
   b. If the difference is larger than a threshold, change model parameters (or model type) and repeat steps (3b)-(4).
   c. If the difference is less or equal to threshold, the conductor roughness model is found.
      It is known that the conductor roughness effect causes signal degradation (losses and dispersion) that are similar to the signal degradation caused by dielectrics [8], [9]. Thus, it is important to separate the effects of losses and dispersion properly between the conductor roughness and dielectric models, or understand the consequences of not doing such separation. There are four scenarios to build the conductor surface roughness model without and with separation of the loss and dispersion effects between the dielectric and conductor surface roughness models:
1) Optimize dielectric model to fit measured and modeled GMS-parameters following the procedure in FIG. 1 and do not use any additional conductor roughness model. The dielectric model will include effect of conductor surface roughness. Such model may be suitable for the analysis of a particular transmission line and has to be rebuilt if strip width or line type is changed. This combined model may be acceptable in cases of high-loss dielectrics when the effect of conductor roughness is minimal. This case is similar to the dielectric model identification described in [13], [14], but with rough conductors.
2) Define dielectric model with the data available from the dielectric manufacturer and then identify a roughness model (a roughness correction coefficient) with GMS-parameters following the procedure in FIG. 1. This approach works well if a manufacturer has reliable procedure to identify the dielectric properties (most of them do). Wideband Debye model can be defined with just one value of dielectric constant and loss tangent specified at one frequency point [13]. This is the simplest way to identify the conductor roughness model.
3) If dielectric model is not available, identify dielectric and conductor roughness models separately. In addition to two line segments with rough copper, make two or more transmission line segments with flat rolled copper on the same board. First, use segments with flat copper to identify parameters in dielectric model following the procedure in FIG. 1. Then use the identified dielectric model for rough segments and identify the conductor roughness model following the same procedure FIG. 1, but for the roughness model. This is the simplest way to separate loss and dispersion effects in conductor surface roughness and dielectric models.
4) If dielectric model is not available, identify dielectric and conductor roughness models simultaneously. It can be done with multiple line pairs with different widths of strips in each pair (narrow, regular and wide strips made of the same rough copper for instance). Dielectric model and conductor roughness model parameters can be optimized simultaneously following the procedure in FIG. 1, until differences of GMS-parameters for segments with all strip widths reach the stopping criteria. The resulting dielectric and roughness models will be usable for a given range of the strip widths. Though the procedure is the most complicated and may lead to multiple possibilities (ambiguity).
   Model of Transmission Line with Rough Conductor

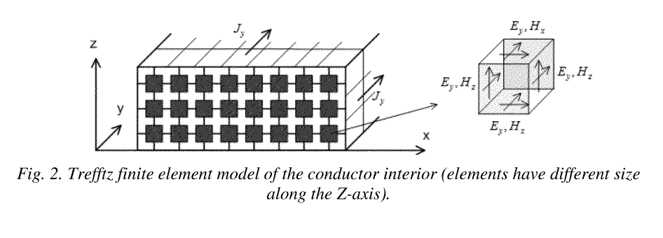

A part of the identification procedure described here must be reliable model that allows computation of the generalized modal S-parameters with all important conductor and dielectric related dispersion and loss effects included (step 3b in FIG. 1). The model may be based on quasi-static analysis for transmission lines with homogeneous or almost homogeneous dielectrics. In case of multiple different dielectrics used in transmission line cross-section (inhomogeneous dielectric), full-wave electromagnetic analysis may be required to account for the high-frequency dispersion. For analysis here we will use a hybrid technique based on the method of lines extended to planar 3D structures introduced in [16] and combined with the Trefftz finite elements discussed in [17] to simulate the interior of the conductor with a rough surface. We first mesh the conductor interior with rectangular Treftz-Nikol'skii elements [17] with one component of electric field along the conductor and two components of magnetic field in the plane of the conductor cross-section as shown in FIG. 2.

Trefftz elements are built with the plane-wave solutions of Maxwell's equations in element medium as the intra-element basis functions. The intra-metal element can be described by a differential impedance matrix Zₑₗ that relates local voltages (integral of electric field) and surface currents (integral of magnetic field) on the faces of element as follows [17]:

$${Z}_{el} = {Z}_{m} \cdot [ \begin{matrix}\frac{coth ( Γ \cdot dz )}{dx} & \frac{1}{Γ \cdot dx \cdot dz} & \frac{csesh ( Γ \cdot dz )}{dx} & \frac{1}{Γ \cdot dx \cdot dz} \\ \frac{1}{Γ \cdot dx \cdot dz} & \frac{coth ( Γ \cdot dx )}{dz} & \frac{1}{Γ \cdot dx \cdot dz} & \frac{csech ( Γ \cdot dx )}{dz} \\ \frac{csech ( Γ \cdot dz )}{dx} & \frac{1}{Γ \cdot dx \cdot dz} & \frac{coth ( Γ \cdot dz )}{dx} & \frac{1}{Γ \cdot dx \cdot dz} \\ \frac{1}{Γ \cdot dx \cdot dz} & \frac{csech ( Γ \cdot dx )}{dz} & \frac{1}{Γ \cdot dx \cdot dz} & \frac{coth ( Γ \cdot dx )}{dz}\end{matrix} ] \qquad ( 1 )$$

where

$$Γ = ( 1 + i ) \frac{1}{δ}$$

is the intra-metal plane wave propagation constant,

$${Z}_{m} = \frac{Γ}{σ}$$

is the intra-metal plane wave impedance,

$$δ = \sqrt{\frac{2}{2 π \cdot f \cdot μ \cdot σ}}$$

is the skin depth, σ is the metal conductivity, μ is the metal permeability, f is the frequency, and dx, dz are element sizes along the X and Y axes as shown in FIG. 2. The element of Trefftz-Nickol'skii (1) is reciprocal and conservative at all frequencies. In addition, the element matrix (1) has correct low and high-frequency asymptotes. Skin-effect is automatically accounted for in the element formulation—element size can be much larger than the skin depth. In fact, even one element can be considered as a good approximation of a typical strip conductor. A detailed analysis of the accuracy of Trefftz elements in analysis of conductors is provided in [8].

The impedance matrices Zₑₗ of all the elements in the conductor cross-section are simply connected, following the procedure similar to that described in [17]. A conductor impedance matrix Z_{cs} that relates local voltages and surface currents at the surface of the conductor is formed. This procedure of connecting matrices enforces the boundary conditions between two Trefftz elements. The final differential surface impedance matrix for the conductor interior is united with the grid Green's function (or matrix) derived in [16], describing multi-layered dielectric and conductive planes and built with the method of lines. Dielectric models are used to compute Green's matrix as described in [16]. With this hybrid technique, we compute admittance parameters for two segments of transmission lines and extract complex propagation constant Γ_{TL}, characteristic impedance, complex impedance and admittance per unit length following the procedure introduced in [18]. Using the computed Γ_{TL}, the generalized modal S-matrix of the line segment with length l can be computed as:

$$Sg = [ \begin{matrix}0 & exp ( - {Γ}_{TL} \cdot l ) \\ exp ( - {Γ}_{TL} \cdot l ) & 0\end{matrix} ] \qquad ( 2 )$$

Matrix Sg is normalized to the complex frequency-dependent characteristic impedance of the line and does not have reflection (reflection-less). In the case of a coupled or multi-conductor line, such a matrix has zero modal transformation terms as shown in [13]. GMS-parameters can also be extracted from measured S-parameters of the two line segments as shown in [13]. Extraction from the measured data can be done without any knowledge of the characteristic impedance of the lines. The measured GMS-parameters will have exactly zero reflection and mode transformation coefficients. Matching magnitude and group delay or phase of computed and measured generalized modal transmission coefficients is the simplest possible way to identify the material properties.

To account for roughness, the conductor surface impedance matrix Z_{cs} can be adjusted to simulate additional losses and the inductance of the rough conductor surface. A roughness correction coefficient can be used to adjust the cross-section impedance matrix before uniting it with the method of lines Green's matrix operator which describes the multilayered dielectric media. For that purpose, we first compute correction coefficients and place them in the diagonal elements of matrix Kₛᵣ and then multiply the conductor impedance matrix with the correction matrix as follows:

Z_{cs}″=Kₛᵣ^{1/2}·Z_{cs}·Kₛᵣ^{1/2} (3)

Matrix Kₛᵣ has the same dimension as the conductor cross-section impedance matrix Z_{cs}. The correction coefficients may be different for different sides of the strip. For example, if the top and bottom strips have different roughness type or values, the corresponding correction coefficients on diagonal of Kₛᵣ can be adjusted to account for the differences. This will force current re-distribution in the conductor cross-section and minimizes total conductor losses (though, overall losses will be always larger with the rough conductor surface). Similar surface impedance correction is used here in the spectral domain to account for roughness of the conductive plane layers. GMS-parameters (2) computed as described here will include loss and dispersion from dielectrics and conductor, conductor roughness and high-frequency dispersion as well. Any roughness correction coefficient introduced in [3], [4], [8], [9], [11], [12] can be used in (3) for adjustment of the surface impedance operator. Both the real and imaginary parts of the surface impedance are adjusted simultaneously. This implies that not only the resistance, but also the internal conductor inductance is adjusted to account for the roughness. Note that the approach with correction coefficients (3) can be considered as the local version of the total resistance adjustment suggested in [2]. Typically, attenuation is adjusted with a roughness correction coefficient that leads to non-causal results. The approach with the total resistance is causal, but less accurate because there is no possible way of accounting for roughness on a particular surface in addition to the quasi-static approximation (no high-frequency dispersion).

Finally, for a practical illustration of the roughness correction algorithm we can use modified Hammerstad's correction coefficient MHCC [8] defined as follows:

$${K}_{rh} = 1 + ( \frac{2}{π} \cdot arctan [ 1.4 {( \frac{Δ}{δ} )}^{2} ] ) \cdot ( RF - 1 ) \qquad ( 4 )$$

where δ is the skin depth defined earlier, Δ is RMS peak-to-valley distance (may be also considered as a parameter to fit), and RF is a new parameter that is called roughness factor (RF>1). RF characterizes the expected maximal increase in conductor losses due to roughness effect. RF=2 gives the classical Hammerstad's equation [11], [12] with maximal possible increase in conductor loss equal to 2.

Another form of the roughness correction (4) implemented in Simbeor software as an alternative to the MHCC (Simbeor correction coefficient or SCC) can be defined as follows:

$${K}_{rs} = 1 + ( tanh [ 0.56 \frac{Δ}{δ} ] ) \cdot ( RF - 1 ) \qquad ( 5 )$$

Parameters of this model are exactly the same as in (4).

For comparison, we will also use roughness correction coefficient derived from Huray's snowball model presented in [4] for the case of all balls with one size (Huray's snowball correction coefficient of HSCC). It can be written as surface impedance correction coefficient as follows:

$${K}_{rhu} = 1 + ( \frac{N \cdot 4 π \cdot {r}^{2}}{{A}_{hex}} ) / ( 1 + \frac{δ}{r} + \frac{{δ}^{2}}{2 \cdot {r}^{2}} ) \qquad ( 6 )$$

and defined with tile base size Ahex, ball radius r and the number of balls N.

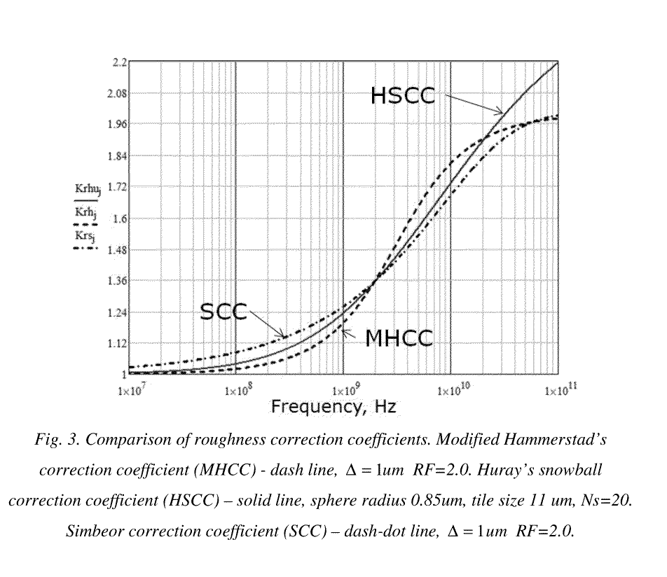

All three correction coefficients are plotted in FIG. 3 for comparison—parameters of the models can be adjusted to have a difference within 10%, up to 50 GHz. Note that all three coefficients are physical—they are based on models that describe increase in conductor surface absorption when skin-effect is developed on a non-flat surface. In other words, the models describe skin-effect on rough surfaces. The differences are in the approximation of non-flatness or micro-structure of the surface.

The outlined algorithm was first published in [8] and used for analysis of plated rough conductors in [15].

### Practical Example

As an example of conductor roughness model identification up to 50 GHz for 25-30 Gbps data channel we use measured data provided by David Dunham from Molex for one of the material characterization boards made with Nelco N4000-13EP dielectric and copper foil with very low profile roughness (VLP) and described in detail in [19].

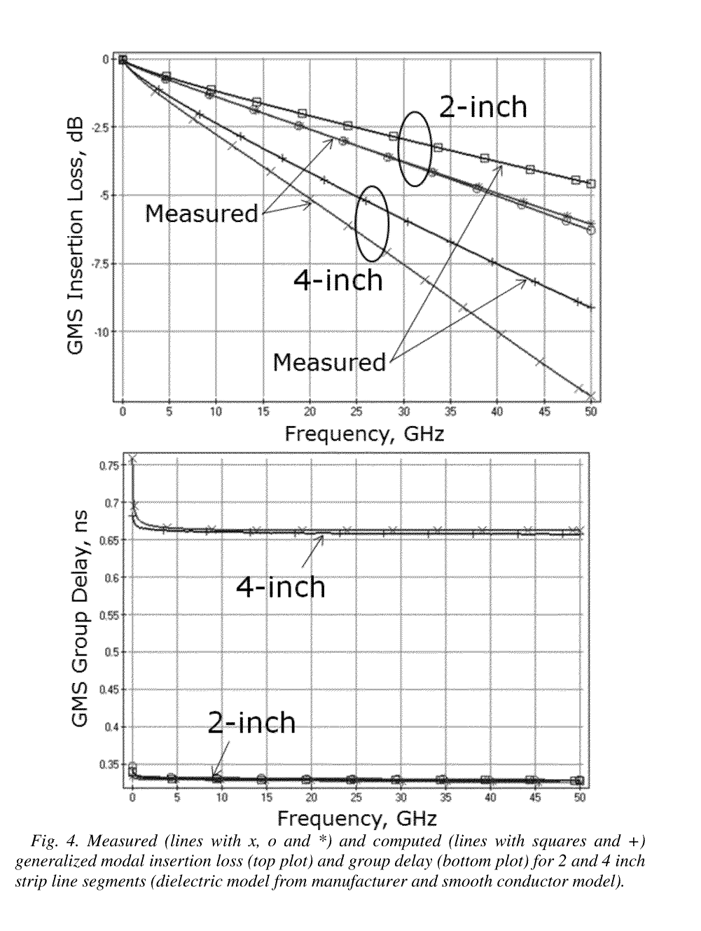

A set of 2, 4 and 6-inch strip line segments was used to extract reflection-less GMS-parameters for 2 and 4 inch line segments shown in FIG. 4 (following steps 1-2 of the procedure shown in FIG. 1). Dielectric specifications for N4000-13EP material show that this dielectric may have dielectric constant (Dk) from 3.6 to 3.7 and loss tangent (LT) from 0.008 to 0.009. We first follow steps 3a and 3b in FIG. 1 and compute GMS-parameters for 2 and 4 inch segments with the electromagnetic analysis with wideband Debye model and given Dk=3.8 and LT=0.008 defined at 10 GHz (shown as lines with squares and pluses in FIG. 4). The difference in the measured and computed group delay is small, but the difference in GMS insertion loss is huge—this is not acceptable model. Dk in the model is slightly increased to match group delays—that increase can be explained by the layered structure and anisotropy of the dielectric. There are a couple of options how to minimize the difference between the simulated and measured GMS-parameters. LT may be increased to 0.0112 to have acceptable match for the insertion loss. This is scenario 1 from the “Identification of conductor roughness model” section, following steps 4a-4c of the procedure in FIG. 1. The roughness effect will be included into the dielectric model in that case. As was mentioned, this lead to a model that is usable only for a particular transmission line used in the identification procedure. Another option is to assume that the dielectric data from the manufacturer are actually correct, and attribute all observed excessive losses to the conductor roughness. This is scenario 2 from the “Identification of conductor roughness model” section.

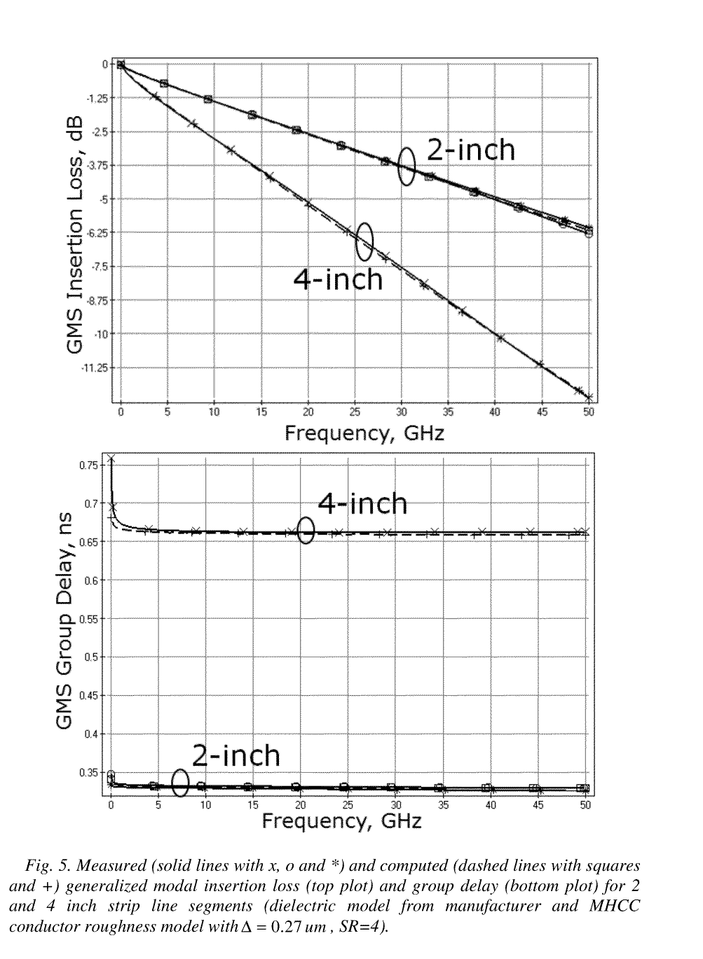

Following steps 4a-4c of the procedure shown in FIG. 1 with the modified Hammerstad's correction coefficient MHCC (4), nearly perfect correspondence of measured and computed models can be achieved with the surface roughness parameter Δ adjusted to 0.27, and roughness factor RF adjusted to 4 and conductor resistivity adjusted to 1.1 (relative to resistivity of annealed copper). Measured GMS-parameters and computed with the final roughness model are shown in FIG. 5. Similar fit can be achieved with SCC (6) and HSCC (7).

As the result of this simple example we ended up with two models—with LT=0.0112 and no roughness (combined model) and another model with LT=0.008 (as in the dielectric specs) and additional model for the conductor roughness. Both models are suitable for the analysis of the 8.5 mil strip line on that board. However, if strips with different width are used, the model without roughness effect will be less accurate, assuming that all additional losses observed in FIG. 4 are due to conductor roughness. For instance, model with increased LT and without roughness predicts up 40% smaller losses for differential strip with 4 mil wide strips with 4 mil distance at all frequencies above 3-5 GHz. In other words, the model with the rough conductor produces more accurate insertion loss estimation for broader range of strip widths. This example illustrates typical situation and importance of proper dielectric and conductor roughness model identification to have analysis to measurement correspondence for a particular board and t-lines up to 50 GHz. Note that the proper separation of loss and dispersion effects between dielectric and conductor models is very important, but not easy task—it may require more test structures on the same board (see scenarios 3 and 4 in the “Identification of conductor roughness model” section). Though, if dielectric manufacturer used smooth conductors to identify dielectric parameters, that model can be used to identify parameters of the conductor roughness as it is done here.

Although illustrative embodiments have been described herein with reference to the accompanying drawings is exemplary of a preferred present invention, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

1. A method of identifying conductor surface roughness model associated with a transmission line conductor by executing computer-executable instructions stored on a nontransitory computer-readable medium, the method comprises the steps of:
measuring scattering parameters (S-parameters) for at least two transmission line segments of different length and substantially identical cross-section and conductor roughness profiles with the investigated rough conductors;
determining non-reflective, generalized modal scattering parameters of the said transmission line segment difference based on the measured S-parameters of two transmission line segments;
computing generalized modal scattering parameters of the line difference segment by solving Maxwell's equations for geometry of the line cross-section with a given conductor surface roughness model;
wherein for the said generalized s-parameter model using a given conductor surface roughness model and guess values of the model parameters, changing conductor surface roughness model type and parameters until computed and measured generalized model scattering parameters match.

2. The method of identifying conductor surface roughness model associated with a transmission line conductor by executing computer-executable instructions stored on a nontransitory computer-readable medium of claim 1, wherein the said measuring scattering parameters may be measured using network analyzer including Vector Network Analyzer (VNA) or Time-Domain Network Analyzer (TDNA) or any other instrument or model that measures complex scattering parameters (S-parameters) of a multiport structure; wherein the standard Short-Open-Load-Through (SOLT) calibration of VNA to the probe tips or to the coaxial connector may be optionally used for the said measurement of S-parameters for the said two line segments.

3. The method of identifying conductor surface roughness model associated with a transmission line conductor by executing computer-executable instructions stored on a nontransitory computer-readable medium of claim 2, wherein the said transmission line segments include at least two transmission line segments with substantially identical cross-section with investigated rough conductors and the said two transmission line segments must have different length; wherein one said transmission line segment is shorter and another said transmission line segment is longer.

4. The method of identifying conductor surface roughness model associated with a transmission line conductor by executing computer-executable instructions stored on a nontransitory computer-readable medium of claim 3, wherein the geometry of the cross-section and dielectric model parameters must be known and both segments are equipped with either coaxial connectors or conductive probe pads to measure S-parameters over a given frequency range; and wherein the said transmission line segments may be one or multi-conductor strip or micro-strip line, coplanar waveguide or any other line type.

5. The method of identifying conductor surface roughness model associated with a transmission line conductor by executing computer-executable instructions stored on a nontransitory computer-readable medium of claim 4, further comprising the step of computing generalized modal S-parameters of line segment difference by solving Maxwell's equations for the transmission line cross-section with possibility to choose conductor surface roughness model for at least one conductor in the line cross-section; and further constructing generalized modal S-parameters of line segment with length l, for a transmission line with N modes (N-conductor line), computed as equation:
$$\tilde{S} g ( f , l ) = [ \begin{matrix}0 & Sm \\ Sm & 0\end{matrix} ] , \\ Sm = diag ( {e}^{- {Γ}_{n} ( f ) \cdot l} , n = 1 , … , N )$$
where Γₙ(f)=αₙ(f)+i·βₙ(f), n=1, . . . , N are complex frequency-dependent propagation constants (Gammas) of the transmission line modes computed by solving Maxwell's equations.

6. The method of identifying conductor surface roughness model associated with a transmission line conductor by executing computer-executable instructions stored on a nontransitory computer-readable medium of claim 5, wherein the said solution of the Maxwell's equations can be computed with any numerical method applied to the said line cross-section or to a line segment and such model includes dispersive effects of conductors including skin-effect and effect of conductor roughness, high-frequency dispersion due to inhomogeneous dielectric and dispersive dielectric model equivalent to wideband Debye model or multi-pole Debye model.

7. The method of identifying conductor surface roughness model associated with a transmission line conductor by executing computer-executable instructions stored on a nontransitory computer-readable medium of claim 6, further comprising the steps of
a) optimizing said conductor surface roughness model parameters and model type by adjusting conductor surface roughness model parameters and re-simulating the line segment to match magnitude and phase of the measured and simulated modal transmission coefficients; and
b) comparing the measured and computed generalized modal S-parameters, if they match according to a pre-defined criterion, conductor surface roughness is found, else if not matched, changing model parameters (or model type) and repeat steps a) and b).

8. A method of identifying conductor surface roughness model associated with a transmission line conductor by executing computer-executable instructions stored on a nontransitory computer-readable medium, the method comprises the steps of:
a) obtaining measured scattering parameters (S-parameters) for at least two transmission line segments of different length and substantially identical cross-section with the investigated rough conductors;
b) determining non-reflective, generalized modal scattering parameters of the said transmission line segment difference based on the measured S-parameters of two transmission line segments;
c) computing generalized modal scattering parameters of the line difference segment by solving Maxwell's equations for geometry of the line cross-section with a given conductor surface roughness model;
wherein the said generalized s-parameter model uses a given conductor surface roughness model; and
d) matching computed and measured generalized model scattering parameters by changing model types and parameters.

9. The method of identifying conductor surface roughness model associated with a transmission line conductor by executing computer-executable instructions stored on a nontransitory computer-readable medium of claim 8, wherein the said measuring scattering parameters may be measured using network analyzer including Vector Network Analyzer (VNA) or Time-Domain Network Analyzer (TDNA) or any other instrument or model that measures complex scattering parameters (S-parameters) of a multiport structure; wherein the standard Short-Open-Load-Through (SOLT) calibration of VNA to the probe tips or to the coaxial connector may be optionally used for the said measurement of S-parameters for two line segments; and
the said transmission line segments include at least two transmission line segments with substantially identical cross-section with investigated rough conductors and the said two transmission line segments must have different length; wherein one said transmission line segment is shorter and another said transmission line segment is longer.

10. The method of identifying conductor surface roughness model associated with a transmission line conductor by executing computer-executable instructions stored on a nontransitory computer-readable medium of claim 9, further comprising the step of:
computing generalized modal S-parameters of line segment difference by solving Maxwell's equations for the transmission line cross-section with possibility to choose conductor surface roughness model for at least one conductor in the line cross-section; and further constructing generalized modal S-parameters of line segment with length l, for a transmission line with N modes (N-conductor line), computed as equation:
$$\tilde{S} g ( f , l ) = [ \begin{matrix}0 & Sm \\ Sm & 0\end{matrix} ] , \\ Sm = diag ( {e}^{- {Γ}_{n} ( f ) \cdot l} , n = 1 , … , N )$$
where Γₙ(f)=αₙ(f)+·βₙ(f), n=1, . . . , N are complex frequency-dependent propagation constants (Gammas) of the transmission line modes computed by solving Maxwell's equations.

11. The method of identifying conductor surface roughness model associated with a transmission line conductor by executing computer-executable instructions stored on a nontransitory computer-readable medium of claim 10, wherein the said solution of the Maxwell's equations can be computed with any numerical method applied to the said line cross-section or to a line segment and such model includes dispersive effects of conductors including skin-effect and effect of conductor roughness, high-frequency dispersion due to inhomogeneous dielectric and dispersive dielectric model equivalent to wideband Debye model or multi-pole Debye model.

12. The method of identifying conductor surface roughness model associated with a transmission line conductor by executing computer-executable instructions stored on a nontransitory computer-readable medium of claim 11, further comprising the steps of
d) optimizing said conductor surface roughness model parameters and model type by adjusting conductor surface roughness model parameters and re-simulating the line segment to match magnitude and phase of the measured and simulated modal transmission coefficients; and
e) comparing the measured and computed generalized modal S-parameters, if they match according to a pre-defined criterion, the conductor surface roughness model is found, else if not matched, changing model parameters (or model type) and repeat steps d) and e).

13. A method of identifying conductor surface roughness model associated with a transmission line conductor by executing computer-executable instructions stored on a nontransitory computer-readable medium, the method comprises the steps of:
a) measuring scattering parameters (S-parameters) for at least two transmission line segments of different length and substantially identical cross-section with the investigated rough conductors;
b) determining non-reflective, generalized modal scattering parameters of the said transmission line segment difference based on the measured S-parameters of two transmission line segments; and
c) computing generalized modal scattering parameters of the line difference segment by solving Maxwell's equations for geometry of the line cross-section with a given conductor surface roughness model;
wherein the said generalized s-parameter model uses a given conductor surface roughness model and guess values of the model parameters, and wherein the geometry of the cross-section and dielectric model parameters must be known and both segments are equipped with either coaxial connectors or conductive probe pads to measure S-parameters over a given frequency range; and wherein the said transmission line segments may be one or multi-conductor strip or micro-strip line, coplanar waveguide or any other line type.

14. The method of identifying conductor surface roughness model associated with a transmission line conductor by executing computer-executable instructions stored on a nontransitory computer-readable medium of claim 13, wherein the said measuring scattering parameters may be measured using network analyzer including Vector Network Analyzer (VNA) or Time-Domain Network Analyzer (TDNA) or any other instrument or model that measures complex scattering parameters (S-parameters) of a multiport structure; wherein only the standard Short-Open-Load-Through (SOLT) calibration of VNA to the probe tips or to the coaxial connector may be optionally used for the said measurement of S-parameters for two line segments; and
the transmission line segments include at least two transmission line segments with substantially identical cross-section with investigated rough conductors and the said two transmission line segments must have different length; wherein one said transmission line segment is shorter and another said transmission line segment is longer.

15. The method of identifying conductor surface roughness model associated with a transmission line conductor by executing computer-executable instructions stored on a nontransitory computer-readable medium of claim 14, further comprising the step of
computing generalized modal S-parameters of line segment difference by solving Maxwell's equations for the transmission line cross-section with possibility to choose conductor surface roughness model for at least one conductor in the line cross-section; and further constructing generalized modal S-parameters of line segment with length l, for a transmission line with N modes (N-conductor line), computed as equation:
$$\tilde{S} g ( f , l ) = [ \begin{matrix}0 & Sm \\ Sm & 0\end{matrix} ] , \\ Sm = diag ( {e}^{- {Γ}_{n} ( f ) \cdot l} , n = 1 , … , N )$$
where Γₙ(f)=αₙ(f)+i·βₙ(f), n=1, . . . , N are complex frequency-dependent propagation constants (Gammas) of the transmission line modes computed by solving Maxwell's equations.

16. The method of identifying conductor surface roughness model associated with a transmission line conductor by executing computer-executable instructions stored on a nontransitory computer-readable medium of claim 15, wherein the said solution of the Maxwell's equations can be computed with any numerical method applied to the said line cross-section or to a line segment and such model include dispersive effects of conductors including skin-effect and effect of conductor roughness, high-frequency dispersion due to inhomogeneous dielectric and dispersive dielectric model equivalent to wideband Debye model or multi-pole Debye model.

17. The method of identifying conductor surface roughness model associated with a transmission line conductor by executing computer-executable instructions stored on a nontransitory computer-readable medium of claim 16, further comprising the steps of
d) optimizing said conductor surface roughness model parameters and model type by adjusting conductor surface roughness model parameters and re-simulating the line segment to match magnitude and phase of the measured and simulated modal transmission coefficients; and
e) comparing the measured and computed generalized modal S-parameters, if they match according to a pre-defined criterion, the conductor surface roughness model is found, else if not matched, changing model parameters (or model type) and repeat steps d) and e).
